(19) United States
(12) Patent Application Publication
(10) Pub. No.: US 2009/0115760 A1
(43) Pub. Date: May 7, 2009

(54) Field-Through Compensation Circuit and Display Device

(76) Inventors: Hirotaka HAYASHI, Fukaya-shi (JP); Takashi Nakamura, Saitama-shi (JP); Norio Tada, Tokyo (JP); Takayuki Imai, Fukaya-shi (JP); Hiroki Nakamura, Ageo-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/942,491

(22) Filed: Nov. 19, 2007

(30) Foreign Application Priority Data
Dec. 5, 2006 (JP) 2006-328528

(51) Int. Cl. G09G 5/00; G09G 3/36

(52) U.S. Cl. 345/211; 345/87

(57) ABSTRACT

In order to reduce a field-through voltage generated by switching elements, and to decrease a difference between the field-through voltages generated by the respective switching elements arranged on the same scanning line, a negative charge, which is leaked when an input switching element SWa is changed from ON to OFF, is cancelled by using a positive charge discharged by changing a field-through compensation switch from ON to OFF.

### CROSS-REFERENCE TO RELATED APPLICATIONS

This application is based upon and claims the benefit of priority from Japanese Patent Application No. 2006-328528 filed Dec. 5, 2006; the entire contents of which are incorporated herein by reference

### BACKGROUND OF THE INVENTION

1. Field of the Invention

The present invention relates to a display device that generates a field-through voltage.

2. Description of the Related Art

In recent years, the development of the liquid crystal display device having a liquid crystal screen has been actively pursued in view of a reduction in thickness, weight and power consumption.

The liquid crystal display device of this type includes mainly a simple-matrix-type liquid crystal display device and an active-matrix-type liquid crystal display device. Particularly, the active-matrix-type liquid crystal display device is widely used in a personal computer, TV, etc., since switching can be performed for each pixel to obtain high image quality.

Moreover, a liquid crystal display device that has been recently developed additionally has an image-capturing function, instead of a liquid crystal display device singly including a display function of displaying an image. The liquid crystal display device having the image-capturing function detects direct light from the sun, an illuminator and etc., or indirect light reflected from an object such as a finger and etc., by using photodiodes and the like. The liquid crystal display device including the image-capturing function is described in, for example, Japanese Patent Application Laid-open Publication No. 2005-328352.

The aforementioned liquid crystal display device has various kinds of switching elements connected to scanning lines and signal lines. However, there is a problem in which a field-through voltage is generated when a control is made so as to turn the switching elements from ON to OFF. Furthermore, field-through voltages generated by the respective switching elements arranged on the same scanning line varies, so that an image may deteriorate.

### SUMMARY OF THE INVENTION

It is an object of the present invention to reduce a field-through voltage generated by a switching element, and to decrease a difference between field-through voltages generated by the respective switching elements arranged on the same scanning line.

A field-through compensation circuit of a first aspect of the present invention includes: a first switching element; and a first field-through compensation switch connected to the first switching element in series to cancel, a first electric charge leaked when the first switching element is changed from ON to OFF, by using a second electric charge having polarity opposite to that of the first electric charge.

According to the present invention, the first electric charge, which is leaked when the first switching element is changed from ON to OFF, is cancelled with the second electric charge having polarity opposite to that of the first electric charge. Thus, it is possible to reduce the first field-through voltage generated by the first switching element.

The field-through compensation circuit of a second aspect of the present invention further includes: a second switching element connected to the first switching element in parallel; and a second field-through compensation switch connected to the second switching element in series to cancel, a third electric charge leaked when the second switching element is changed from ON to OFF, by using a fourth electric charge having polarity opposite to that of the third electric charge.

According to the present invention, the third electric charge, which is leaked when the second switching element is changed from ON to OFF, is cancelled with the fourth electric charge having polarity opposite to that of the third electric charge. Thus, it is possible to reduce the field-through voltage generated by the second switching element.

A display device of a third aspect of the present invention includes: a plurality of signal lines and a plurality of scanning lines crossing one another; switching elements having a control electrode connected to the corresponding scanning line, and having one electrode connected to the corresponding signal line; and a drive unit that supplies the corresponding scanning lines with a driving signal whose fall characteristic changes stepwise.

According to the present invention, the switching element is driven using the driving signal whose fall characteristic changes stepwise. Thus, it is possible to reduce a potential variation of a control electrode of the switching element at the fall time, and to decrease a difference between field-through voltages generated by the respective switching elements arranged on the same scanning line.

A display device of a fourth aspect of the present invention includes: a plurality of signal lines and a plurality of scanning lines crossing one another; switching elements having a control electrode connected to the corresponding scanning line, and having one electrode connected to the corresponding signal line; and a drive unit that supplies the corresponding scanning line with a driving signal having a fall time, which is longer than or equal to a fall time of a driving signal having a distortion occurring at a terminating end when the driving signal is supplied to a starting end of the corresponding scanning line.

According to the present invention, the scanning line is supplied with the driving signal having a fall time, which is longer than or equal to a fall time of the driving signal having a distortion occurring at the terminating end when the driving signal is supplied to the starting end of the scanning line. Thus, it is possible to equalize the waveform of the driving signal at the starting end of the scanning line and the waveform at the terminating end, and to reduce a difference between field-through voltages generated by the respective switching elements arranged on the same scanning line.

The display device of a fifth aspect of the present invention is that the drive unit uses a resistor and a load capacitor to supply the corresponding scanning line with a driving signal having a fall time which is longer than or equal to a fall time of a driving signal having a distortion occurring at a terminating end when the driving signal is supplied to a starting end of the corresponding scanning line.

### BRIEF DESCRIPTION OF THE DRAWINGS

FIG. 1 is a configuration view illustrating a configuration of a display device according to a first embodiment of the present invention.

FIG. 2 is a configuration view illustrating a configuration of an image-capturing region according to the first embodiment of the present invention.

FIG. 3 is a configuration view schematically illustrating a configuration of a display device as a comparative example.

FIG. 4 is a comparison diagram illustrating comparison in an amount of the voltage stored on the respective sensor capacitors at a starting end and a terminating end that are arranged on the same scanning line using a driving signal with a rectangular wave whose fall characteristic does not change stepwise.

FIG. 5 is an inclined view illustrating a state in which an object has come close to a display unit of the display device.

FIG. 6A is a table illustrating a voltage value detected in each image-capturing region in a comparative example.

FIG. 6B is a table illustrating a voltage value detected in each image-capturing region of the first embodiment.

FIG. 7 is a view illustrating a relationship between a voltage value and a height that is detected by a sensor detection circuit.

FIG. 8 is an inclined view illustrating reconstruction of a detected captured image.

FIG. 9 is a configuration view illustrating a configuration of an image-capturing region according to a second embodiment of the present invention.

FIG. 10 is a configuration view illustrating a configuration of an image-capturing region according to a third embodiment of the present invention.

FIG. 11 is a comparison diagram illustrating comparison in an amount of the voltage stored on the respective sensor capacitors at a starting end and a terminating end that are arranged on the same scanning line using a driving signal with a rectangular wave whose fall characteristic changes stepwise.

FIG. 12 is a configuration view illustrating a configuration of an image-capturing region according to a fourth embodiment of the present invention.

### DESCRIPTION OF THE EMBODIMENTS

### First Embodiment

The following will explain embodiments of the present invention with reference to the drawings.

First, an explanation will be given of a configuration of a display device 1 of a first embodiment of the present invention.

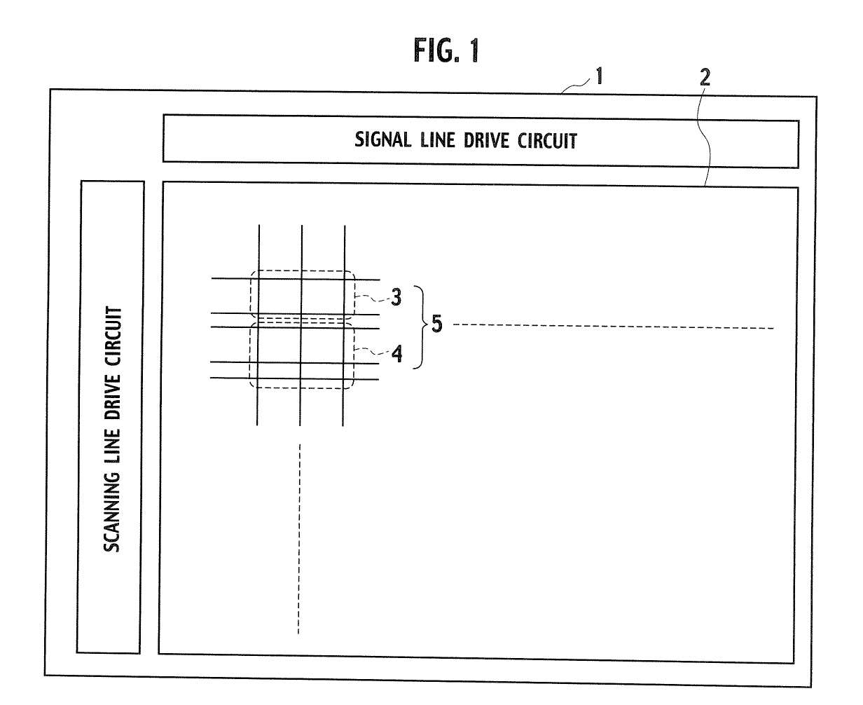

FIG. 1 is a configuration view illustrating the configuration of the display device 1 of the first embodiment of the present invention. In the display device 1 of this embodiment, multiple pixel regions 5 each having a display region 3 and an image-capturing region 4 are arranged in a display unit 2. The display region 3 has a display function of displaying an image. The image-capturing region 4 has an image-capturing function of detecting an object that has come close to the display unit 2.

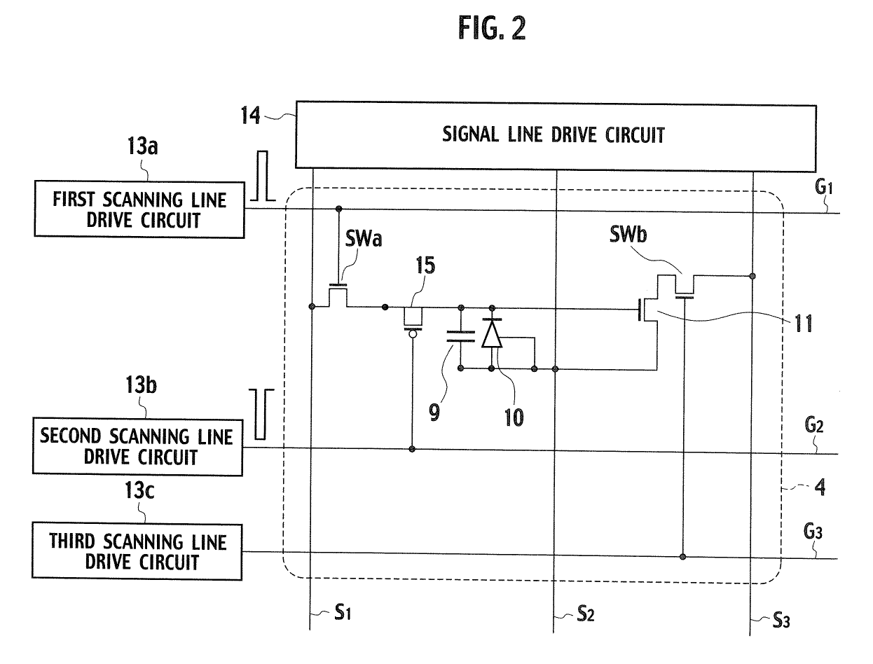

FIG. 2 is a configuration view illustrating a configuration of the image-capturing region 4 in this embodiment. The image-capturing region 4 includes as a basic configuration: first to third signal lines S1 to S3 and first to third scanning lines G1 to G3 which cross one another; an input switching element SWa having a gate electrode connected to the first scanning line G1 and one electrode connected to the first signal line S1; a sensor capacitor 9 having one electrode connected to the other electrode of the input switch element SWa; a photodiode 10 connected to the sensor capacitor 9 in parallel; an amplifying transistor 11 having a gate line connected to one electrode of the sensor capacitor 9 and one electrode connected to the other electrode of the sensor capacitor 9 and the second signal line S2; an output switching element SWb having a gate electrode connected to the third scanning line G3 and further connected between other electrode of the amplifying transistor 11 and the third signal line S3; a first scanning line drive circuit 13a that supplies, to the first scanning line G1, a driving signal which controls ON/OFF of the input switching element SWa; a third scanning drive circuit 13c that supplies, to the third scanning line G3, a driving signal which controls ON/OFF of the output switching element SWb; and a signal line drive circuit 14 that supplies precharge voltages to the first to third signal lines S1 to S3.

The image-capturing region 4 further includes: a field-through compensation switch 15 and a second scanning line drive circuit 13b that controls ON/OFF of the field-through compensation switch 15. The field-through compensation switch 15 is connected between the other electrode of the input switching element SWa and one electrode of the sensor capacitor 9 connected to this other electrode. And the field-through compensation circuit 15, having a gate line connected to the second scanning line G2, operates in a direction opposite to that of the ON/OFF operation of the input switching element SWa. The second scanning line drive circuit 13b supplies the second scanning line G2 with a driving signal having polarity opposite to that of the driving signal supplied by the first scanning line drive circuit 13a.

The input switching element SWa and the field-through compensation switch 15 can be operated using, for example, thin film transistors, and this embodiment gives an explanation using an n-channel thin film transistor and a p-channel thin film transistor as the input switching element SWa and the field-through compensation switch 15, respectively.

An explanation will be next given of the image-capturing function in the image-capturing region 4.

The image-capturing function is operated during a horizontal blanking period of a horizontal period. The horizontal period includes the horizontal blanking period during which the image-capturing function is operated and an image writing period during which a display function is operated. The horizontal blanking period is a period during which multiple image-capturing regions arranged in each column of the display unit 2 are operated.

In an initial state, the first scanning line drive circuit 13a supplies an L (Low) driving signal to the first scanning line G1. The second scanning line drive circuit 13b supplies an H (High) driving signal having an opposite polarity to the second scanning line G2. The third scanning line drive circuit 13c supplies the L driving signal to the third scanning line G3.

In this way, the input switching element SWa and the output switching element SWb are controlled so as to be turned off. The field-through compensation switch 15 operates in a direction opposite to that of the input switch SWa and the second scanning line G2 is supplied with the H driving signal having polarity opposite to that of the L driving signal supplied to the first scanning line G1. For this reason, the field-through compensation switch 15 is also controlled so as to be turned off.

During a next period (precharge period), the signal line drive circuit 14 supplies a predetermined potential to the first to third signal lines S1 to S3. It is here assumed that an electrical potential to be supplied to the first signal line S1 is 5V, an electrical potential to be supplied to the second and third signal lines S2 and S3 is 0V. Moreover, the first scanning line drive circuit 13a supplies the H driving signal to the first scanning line G1. The second scanning line drive circuit 13b supplies the L driving signal to the second scanning line G2. The third scanning line drive circuit 13c sequentially supplies the L driving signal to the third scanning line G3.

In this way, the input switching element SWa and the field-through compensation switch 15 are controlled so as to be turned on, and the first signal line S1 and the sensor capacitor 9 are electrically connected to each other. Then, an initial electrical potential of the sensor capacitor 9 is set to be equal to a threshold value Vth of the amplifying transistor 11. In other words, when the electrical potential supplied to the sensor capacitor 9 is high, the amplifying transistor 11 is controlled so as to be turned on to thereby discharge an electric charge. Consequently, the electrical potential stops at the threshold value Vth of the amplifying transistor 11.

During a next period (image-capturing period), the first scanning line drive circuit 13a supplies the L driving signal to the first scanning line G1. The second scanning line drive circuit 13b supplies the H driving signal to the second scanning line G2. The third scanning line drive circuit 13c sequentially supplies the L driving signal to the third scanning line G3.

In this way, the input switching element SWa and the field-through compensation switch 15 are controlled so as to be turned off, and the first signal line S1 and the sensor capacitor 9 are electrically disconnected from each other. This allows the sensor capacitor 9 to maintain the electrical potential of 5V stored during the previous precharge period. However, the electrical potential is actually reduced to 4.9V due to a field-through voltage (for example, 0.1V) generated when the input switching element SW is controlled so as to be turned off. In this embodiment, there is provided the field-through compensation switch 15 between the input switching element SWa and the sensor capacitor 9. This makes possible it possible to reduce the voltage generated by this field-through. The operation principle to achieve a reduction in this field-through voltage will be explained later.

Under this state, let's assume that the photodiode 10 is irradiated with backlight reflected by an object such as a finger that has come close to the display unit 2 of the display device 2, for example. In this case, the electric charge stored on the sensor capacitor 9 is discharged. On the contrary, in a case where no light is applied, no electric charge is discharged.

During the final period (reading period), the signal line drive circuit 14 supplies a predetermined electrical potential to the first to third signal lines S1 to S3. It is here assumed that an electrical potential to be supplied to the signal line S1 is 5V, an electrical potential to be supplied to the signal line S2 is 0.5V and an electrical potential to be supplied to the signal line S3 is 0V. Moreover, the first scanning line drive circuit 13a sequentially supplies the L driving signal to the first scanning line G1. The second scanning line drive circuit 13b also sequentially supplies the H driving signal to the second scanning line G2. On the other hand, the third scanning line drive circuit 13c supplies the H driving signal to the third scanning line G3.

It is assumed here that, during the previous image-capturing period, the electrical potential of the sensor capacitor 9 is reduced by 1V due to the discharge of electric charge. In this case, a gate potential of the amplifying transistor 11 is Vth−0.5V (=Vth+0.5V−1.0V). On the contrary, when no electric charge is discharged, the gate potential of the amplifying transistor 11 is (Vth+0.5V).

Accordingly, when the electric charge stored on the sensor capacitor 9 is discharged, that is, the object that has come close to the display unit 2 is detected, the amplifying transistor 11 is controlled so as to be turned off. On the other hand, when no electric charge is discharged, that is, no object is detected, the amplifying transistor 11 is controlled so as to be turned on.

In this way, a sensor output circuit (not shown) connected to the third signal line S3 determines each of presence/absence of voltage and a voltage value transmitted from the image-capturing region 4 through the third signal line S3 during the horizontal blanking period, thereby making it possible to capture the image of the object that has come close to the display unit 2.

Alternatively, a single scanning line drive circuit can be used here instead of the first to third scanning line drive circuits 13a to 13c. Moreover, the foregoing electrical potential is simply an example, and is not meant to limit the discussion.

Next, the following will explain the operation principle in which the field-through compensation switch 15 achieves a reduction in the field-through voltage during the image-capturing period.

During the precharge period, the input switching element SWa is controlled so as to be turned on. For this reason, an n-channel having a negative charge (negative electron) is formed between source and drain of an n-channel thin film transistor that constitutes the input switching element SWa. Moreover, the field-through compensation switch 15 is also controlled so as to be turned on. As a result, a p-channel having a positive charge (positive hole) is formed between source and drain of a p-channel thin film transistor that constitutes the field-through compensation switch 15.

During the following image-capturing period, the input switching element SWa is controlled so as to be turned from ON to OFF. For this reason, the negative charge that is charged on the n-type channel is discharged (leaked) to a source electrode or drain electrode of the n-channel thin film transistor. Likewise, the field-through compensation switch 15 is also controlled so as to be turned from ON to OFF. As a result, the positive charge that is charged on the p-type channel is discharged (leaked) to a source electrode or drain electrode of the p-channel thin film transistor.

When no field-through compensation switch 15 is provided, the negative charge leaked from the input switching element SWa flows into the sensor capacitor 9. Thus, the negative charge is cancelled with the positive charge that is charged on one side of the sensor capacitor 9 connected to the input switching element SWa, resulting in a reduction in the voltage stored on the sensor capacitor 9.

On the contrary, in this embodiment, the field-through compensation switch 15 is provided to thereby cancel the negative charge leaked from the input switching element SWa with the positive charge discharged from the field-through compensation switch 15. This allows the field-through voltage to be reduced. Incidentally, the input switching element SWa and the sensor capacitor 15 are directly connected to each other. For this reason, although all negative charge leaked from the input switching element SWa cannot be reduced, the provision of the field-through compensation switch 15 makes it possible to reduce the field-through voltage.

At this time, although the positive charge discharged from the field-through compensation switch 15 flows into the sensor capacitor 9, the same positive charge is stored on one side of the sensor capacitor 9 connected to the field-through compensation switch 15. Thus, no effect is exerted on a change in voltage of the sensor capacitor 9.

The field-through compensation switch 15 of the p-channel thin film transistor is provided between the input switching element SWa of the n-channel thin film transistor and the sensor capacitor 9. Thus, the negative charge, which is charged on the n-channel, leaked when the input switching element SWa is controlled so as to be turned from ON to OFF, is cancelled with the positive charge that is charged on the p-channel of the field-through compensation switch 15. In this way, the field-through voltage can be reduced.

Herein, the display device as a comparative example of this embodiment will be explained.

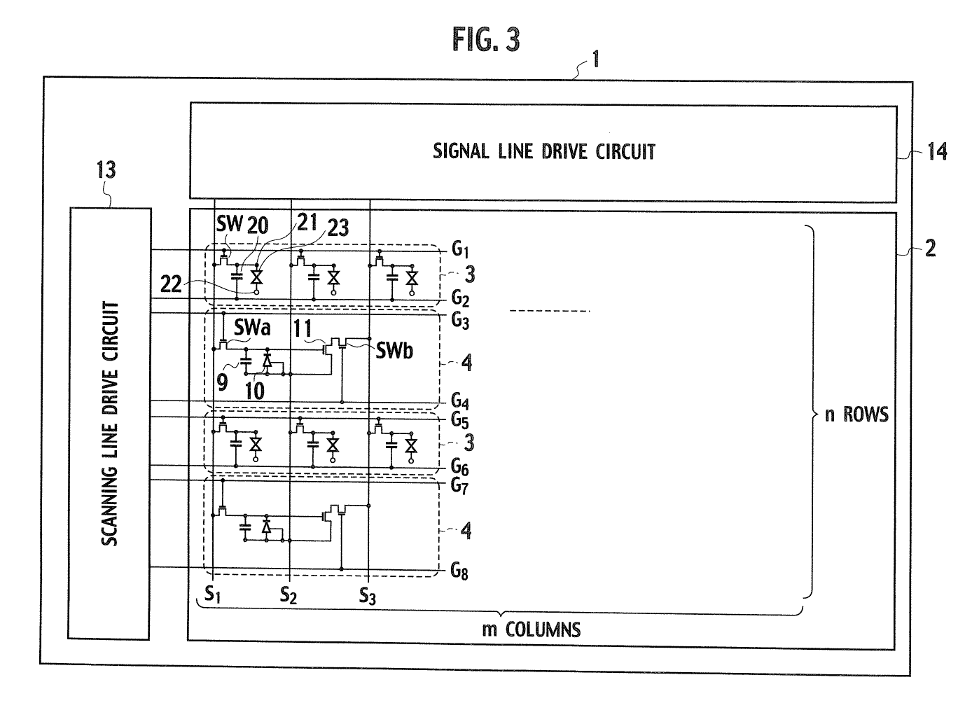

FIG. 3 is a configuration view schematically illustrating a configuration of the display device as a comparative example. The display device 1 includes: the display unit 2 placed at the center of the display device 1; the signal line drive circuit 14 placed at the upper side of the display unit 2; and the scanning line drive circuit 13 placed at the left side of the display unit 2.

In the display unit 2, scanning lines G1 to Gn and signals lines S1 to Sm are arranged in a matrix having n rows and m columns. In blocks divided by the signal lines S1 to Sm and the scanning lines G1 to Gn, display regions 3 and image-capturing regions 4 are formed.

First, the configuration and operation of the display region 3 will be explained. In one block of the display region 3, there are arranged a switching element SW having a control electrode connected to the scanning line Gn and one electrode connected to the signal line Sm, and a storage capacitor 20 connected to the other electrode of the switching element SW and a display electrode 21. A liquid crystal 23 is sandwiched between the display electrode 21 and an opposite electrode 22.

Liquid crystal display is driven by linear sequential drive in which image data signals (driving signal voltage) simultaneously supplied to the signal lines S1 to Sm are sampled by address signals sequentially supplied to the scanning lines G1 to Gn.

Suppose that a fixed time (T1 to Tn) is assigned to each scanning line Gn. When the address signal is applied to the scanning line G1 at a certain selection time T1, all switching elements SW11 to SW1m arranged on the scanning line G1 are turned on, resulting in the switch-on state. Consequently, the image data signals supplied to the signal lines S1 to Sm are transmitted to the display electrode 21 through the respective switching elements SW11 to SW1m, and are supplied to the storage capacitor 20. As a result, a voltage difference occurs between the display electrode 21 and the opposite electrode 22, so that an orientation of liquid crystal molecules in the liquid crystal 23 is controlled. This makes it possible to adjust luminance of incident light from backlight (not shown), and to achieve color display according to the image data signal through a color filter (not shown).

At a next selection time T2, all switching elements SW11 to SW1m on the scanning line G1 are turned off. A pixel selected by the scanning line G1 is electrically separated from the signal lines S1 to Sm. At this time, an image displayed at the selection time T1 is held by the storage capacitor 20 until the address signal is then applied to the scanning line G1. Next, all switching elements SW51 to SW5m arranged on the scanning line G5 are turned on. Then, the image data signal is transmitted to the display electrode 21 and supplied to the storage capacitor 20. The similar operation is repeated afterward to perform display for one screen.

Next, the configuration and operation of the image-capturing region 4 in the comparative example will be explained. In one block of the image-capturing region 4, there are arranged: the input switching element SWa having a control electrode connected to the scanning line Gn, and having one electrode connected to the signal line Sm; the sensor capacitor 9 connected to the other electrode of the input switching element SWa; the photodiode 10 connected to the sensor capacitor 9 in parallel; the amplifier transistor 11 having the control electrode connected to one electrode of the sensor capacitor 9, and having one electrode connected to the other electrode of the sensor capacitor 9 as well as the signal line Sm+1; and the output switching element SW1b having the control electrode connected to the scanning line Gn+1, and further connected between the other electrode of the amplifying transistor 11 and the signal line Sm+2.

Driving to capture the image of the object is carried out in such a way that the precharge voltages supplied to the signal lines S1 to Sm is stored on the sensor capacitor 9 based on the driving signals supplied to the scanning lines G1 to Gn, and a voltage value of the sensor capacitor 9 subjected to an influence of light obtained by the photodiode 10 is used.

In an initial state, the scanning line drive circuit 13 supplies the L (Low) driving signals to the scanning lines G3 and G4. In this way, the input switching element SWa arranged on the scanning line G3 and the output switching element SWb arranged on the scanning line G4 are controlled so as to be turned off.

During a next period (precharge period), the signal line drive circuit 14 supplies precharge voltages to the first to third signal lines S1 to S3. For example, it is assumed that an electrical potential to be supplied to the first signal line is 5V, an electrical potential to be supplied to the second and third signal lines S2 and S3 is 0V. Moreover, the scanning line drive circuit 13 supplies the H (high) driving signal to the third scanning line G3. The L driving signal is sequentially supplied to the scanning line G4. In this way, the input switching element SWa is controlled so as to be turned on, and the signal line S1 and the sensor capacitor 9 are electrically connected to each other. Then, an initial electrical potential of the sensor capacitor 9 is set to be equal to a threshold value Vth of the amplifying transistor 11. In other words, when the electrical potential supplied to the sensor capacitor 9 is high, the amplifying transistor 11 is controlled so as to be turned on to thereby discharge an electric charge. Thus, the potential stops at the threshold value Vth of the amplifying transistor 11.

During a next period (image-capturing period), the scanning line drive circuit 13 supplies the L driving signals to the scanning lines G3 and G4. In this way, the input switching element SWa is controlled so as to be turned off, and the signal line S1 and the sensor capacitor 9 are electrically disconnected from each other. This allows the sensor capacitor 9 to maintain the electrical potential of 5V stored during the previous precharge period. Under this state, let's assume that the photodiode 10 is irradiated with backlight reflected by an object such as a finger that has come close to the display unit 2 of the display device 1, for example. In this case, the electric charge stored on the sensor capacitor 9 is discharged. On the contrary, in a case where no light is applied, no electric charge is discharged.

During the final period (reading period), the signal line drive circuit 14 supplies a predetermined electrical potential to the signal lines S1 to S3. For example, it is assumed that an electrical potential to be supplied to the signal line S1 is 5V, an electrical potential to be supplied to the signal line S2 is 0.5V and an electrical potential to be supplied to the signal line S3 is 0V. Moreover, the scanning line drive circuit 13 sequentially supplies the L driving signal to the scanning line G3. The H driving signal is supplied to the scanning line G4. It is assumed here that, during the previous image-capturing period, the electrical potential of the sensor capacitor 9 is reduced by 1V due to the discharge of electric charge. In this case, the electrical potential of the control electrode in the amplifying transistor 11 is Vth−0.5V (=Vth+0.5V−1.0V). On the contrary, when no electric charge is discharged, the electrical potential of the control electrode in the amplifying transistor 11 is (Vth+0.5V).

Accordingly, when the electric charge stored on the sensor capacitor 9 is discharged, that is, the object that has come close to the display unit 2 is detected, the amplifying transistor 11 is controlled so as to be turned off. On the other hand, when no electric charge is discharged, that is, no object is detected, the amplifying transistor 11 is controlled so as to be turned on.

In this way, a sensor output circuit (not shown) connected to the signal line S3 determines each of presence/absence of voltage and a voltage value transmitted from the image-capturing region 4 through the signal line S3, thereby making it possible to image the object that has come close to the display unit 2.

As explained above, in the display device of the comparative example, by controlling ON/OFF of the switching element SW connected to the signal line Sm and the scanning line Gn or the input switching element SWa, it is possible to operate the display function and the image-capturing function.

However, in the display device of the comparative example, when these switching element SW and input switching element SWa are controlled so as to be turned from ON to OFF, a field-through voltage is generated. The following will explain the reason why the field-through voltage is generated using the input switching element SWa as an example.

One reason why the field-through voltage is generated lies in the structure of the input switching element SWa. A thin film transistor used as the input switching element SWa has a structure in which a gate electrode and a source electrode or drain electrode are overlapped with each other to inevitably form a parasitic capacitance in the overlapped range. Then, an electric charge, which is stored on the parasitic capacitance during the time when the input switching element SWa is controlled so as to be turned on, is redistributed to the parasitic capacitance and the sensor capacitor 9 when the input switching element SWa is controlled so as to be turned from ON to OFF. Accordingly, an amount of electric charge (voltage) stored on the sensor capacitor 9 changes.

Then, the second reason is that an electric charge, which is stored on a channel of the input switching element SWa during the time when the input switching element SWa is controlled so as to be turned on, is discharged when the input switching element SWa is controlled so as to be turned from ON to OFF. In other words, when electrical continuity is maintained between the source electrode and the drain electrode, a negative charge (negative electron), which is distributed to the n-type channel of the n-channel type thin film transistor, is discharged to the source electrode or the drain electron in controlling the input switching element SWa so as to be turned off. The discharged negative charge flows into the sensor capacitor 9 to thereby be coupled with a positive charge stored on the sensor capacitor 9, so that the amount of electric charge of the sensor capacitor 9 is reduced.

In other words, since the field-through voltage is generated when the switching element SW or input switching element SWa is controlled so as to be turned from ON to OFF, the voltage stored on the storage capacitor 20 or sensor capacitor 9 is reduced.

On the other hand, when the field-through voltages generated by all switching elements SW or all input switching elements SWa provided in the display unit 2 are equal to one another, the potential changes of all storage capacitors 20 or all sensor capacitors 9 are also equal to one another. For this reason, if the field-through voltages are equal to one another, an influence, which is exerted on the left and right balance of the image displayed on the display area 3 and that of the captured image detected in the image-capturing region 4, is small.

However, with regard to the address signal by which the display function supplied to the scanning line Gn is operated, or with regard to the driving signal by which the image-capturing function is operated, its fall time varies as the signal travels from the starting end close to the scanning line drive circuit 13 to the terminating end far therefrom due to an influence of such as the resistance of the scanning line Gn, the parasitic capacitance and the like. The following explanation will be given using the input switching element SWa and the sensor capacitor 9 as an example.

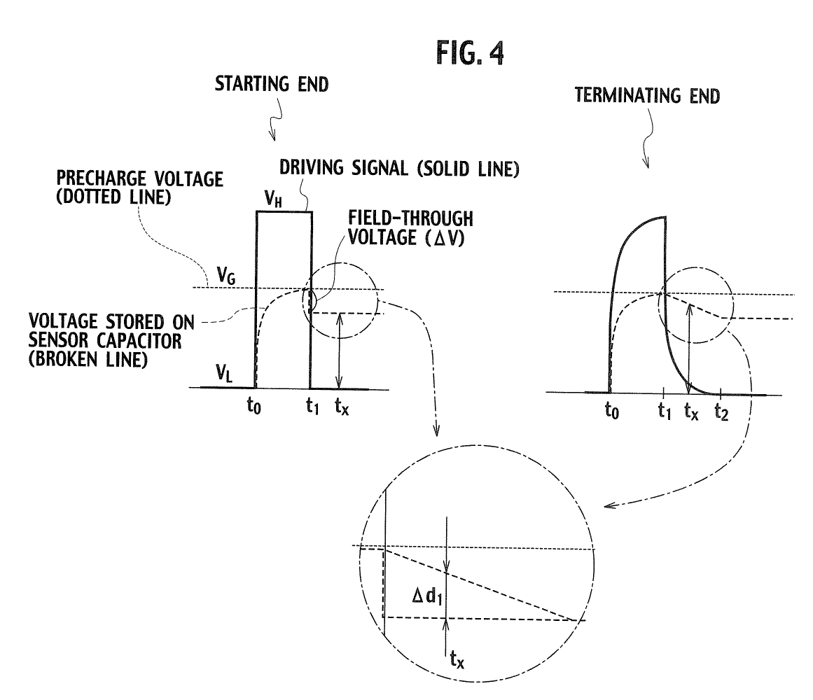

FIG. 4 is a comparison diagram illustrating comparison in an amount of voltage between the respective sensor capacitors 9 at the starting end and the terminating end, respectively. In the same figure, a solid line indicates a waveform of the driving signal that the scanning line drive circuit 13 supplies to the scanning line G3. A dotted line shows a precharge voltage that the signal line driving circuit 14 supplies to the signal line S1. A broken line shows a voltage stored on the sensor capacitor 9.

First, an explanation will be given of the amount of voltage stored on the sensor capacitor 9 at the starting end illustrated left in the same figure. The signal line S1 and the sensor capacitor 9 are electrically connected to each other with the rise (VL→VH) of the driving signal at time t0. In this way, a precharge voltage VG supplied to the signal line S1 by the signal line drive circuit 14 is stored on the sensor capacitor 9. Then, a field-through voltage ΔV is generated in the thin film transistor that constitutes the input switching element SWa with the fall (VH→VL) of the driving signal at time t1. As a result, the amount of voltage stored on the sensor capacitor 9 becomes (VG−ΔV).

The input switching element SWa at the starting end is placed at a position closer to the scanning line drive circuit 13 than the input switching element SWa at the terminating end. For this reason, the driving signal supplied to the control electrode of the input switching element SWa at the starting end is little influenced by the resistance of the scanning line G3, the parasitic capacitance and the like. Accordingly, time, which is required for the voltage of the driving signal supplied to the control electrode to fall from VH to VL, is little generated. Additionally, time, which is required for the occurrence of the filed-through voltage ΔV, is little generated. Therefore, the amount of voltage stored on the sensor capacitor 9 at the starting end becomes (VG−ΔV) at time t1.

Next, an explanation will be given of the amount of the voltage stored on the sensor capacitor 9 at the terminating end illustrated right in the same figure. The input switching element SWa at the terminating end is placed at a position farther from the scanning line drive circuit 13 than the input switching element SWa at the starting end. For this reason, in the driving signal supplied to the control electrode of the input switching element SWa at the terminating end, the waveform is distorted by the influence of such as the parasitic capacitance of the scanning line G3 and the like. As a result, a predetermined time (t1−t2) is required when the voltage of the driving signal supplied to the control electrode falls from VH to VL, and the filed-through voltage ΔV gradually increases along with the predetermined time. Therefore, the amount of the electric charge stored on the sensor capacitor 9 at the terminating end decreases from (VG) to (VG−ΔV) with a change in time (t1→t2).

Finally, the following will explain a difference in an amount of the voltage between the sensor capacitors 9 at the starting end and terminating end illustrated at the lower portion in the same figure. This figure shows the amount of the voltage stored on each of the sensor capacitors 9 at the starting end and the terminating end in an overlapped form. The amount of the voltage stored on each of the sensor capacitors 9 becomes (VG−ΔV) when the aforementioned predetermined time has passed.

However, at the time tx before the passage of the predetermined time, the amount of the field-through voltage generated by each of the input switching elements SWa at the starting end and terminating end differs, so that the amount of the voltage stored on each sensor capacitor 9 also differs.

In other words, in the display device of the comparative example, in the address signal supplied to the scanning line Gn to operate the display function or driving signal to operate the image-capturing function, the waveform is gradually distorted along the scanning line Gn. Then, since a difference occurs in the field-through voltage generated by the respective switching elements SW or input switching elements SWa on the same scanning line Gn, a difference occurs in the voltage stored on the respective connected storage capacitors 20 or sensor capacitors 9.

In the display device of this embodiment, as explained using FIG. 4, the driving signal that controls ON/OFF of the input switching element SWa supplied to the first scanning line G1 is affected by the influence of such as the resistance of the scanning line G1, the parasitic capacitance and the like. Then, the signal waveform is gradually distorted as the signal travels from the starting end close to the first scanning line drive circuit 13a to the terminating end far therefrom. For this reason, at the time tx shown in the same figure, a difference occurs in the field-through voltage generated by the respective switching elements SWs on the first scanning line G1. However, the field-through voltage is reduced by the field-through compensation switch 15 explained in this embodiment, thereby making it possible to reduce the difference between the field-through voltages generated by the respective switching elements SWa at the starting end and the terminating end. In other words, it is possible to reduce the difference between the field-through voltages generated by the respective switching elements arranged on the same scanning line.

Then, the difference between the field-through voltages generated by the respective switching elements SWa at the starting end and the terminating end is reduced, thereby making it possible to equalize the voltages stored on the respective sensor capacitors 9 connected to the respective input switching elements SWa. In other words, it is possible to suppress the characteristic variation of the sensor section having the sensor capacitors 9 and the photodiodes 10 and prevent the occurrence of in-plane inclination in the captured image of the detected object. The following will explain the reason why the in-plane inclination can be prevented.

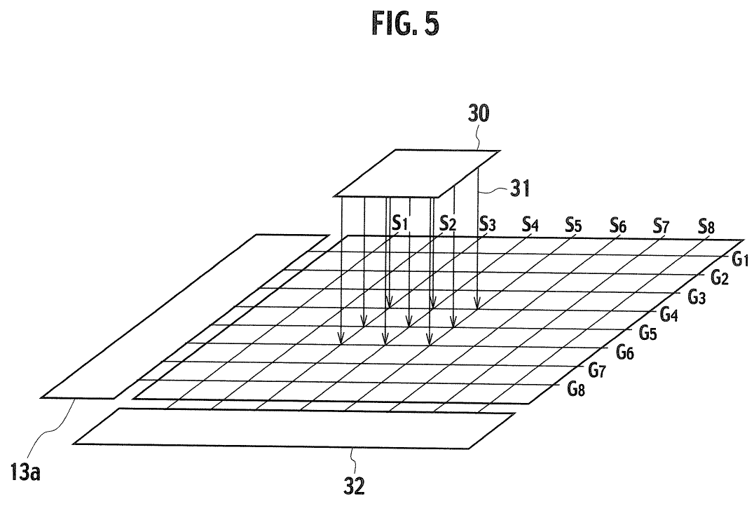

FIG. 5 is an inclined view illustrating a state that an object 30 has come close to the display unit 2 of the display device 1. The object 30 comes close to the display unit 2 in parallel and reflects backlight with which its outer (upper) portion is irradiated from the display device 1. Then, the reflected light 31 is incident on nine sensors formed at the signal lines S3 to S5 and the scanning lines G4 to G6.

As already explained, in the image-capturing region 4 where the object 30 has come close, the amplifying transistor 11 is controlled so as to be turned off, and therefore the voltage to be transmitted to the sensor detection circuit 32 is 0V. On the other hand, in the image-capturing region 4 where the object 30 does not come close, the amplifying transistor 11 is controlled so as to be turned on, and therefore the voltage stored on the sensor capacitor 9 is transmitted to the sensor detection circuit 32. Furthermore, the signal waveform is gradually distorted as the signal travels from the starting end close to the first scanning line drive circuit 13a to the terminating end far therefrom due to the influence of such as the resistance of each scanning line Gn and the like.

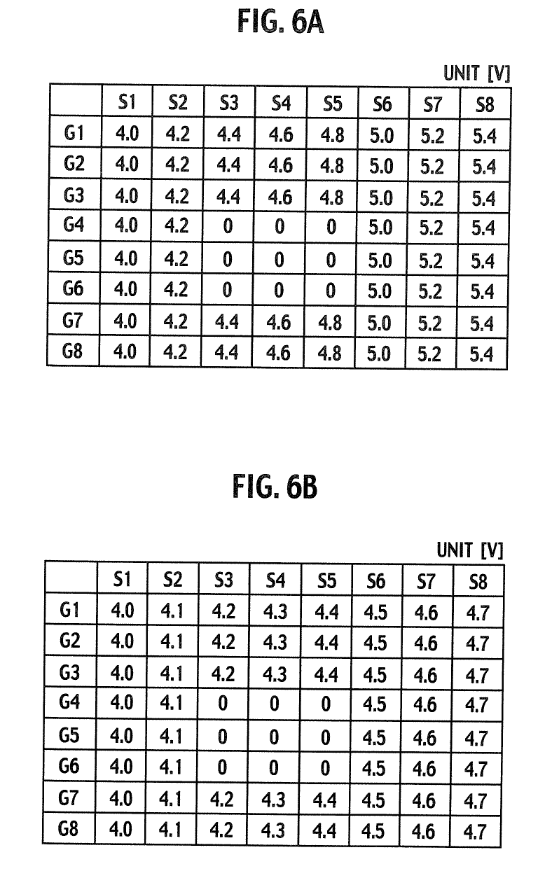

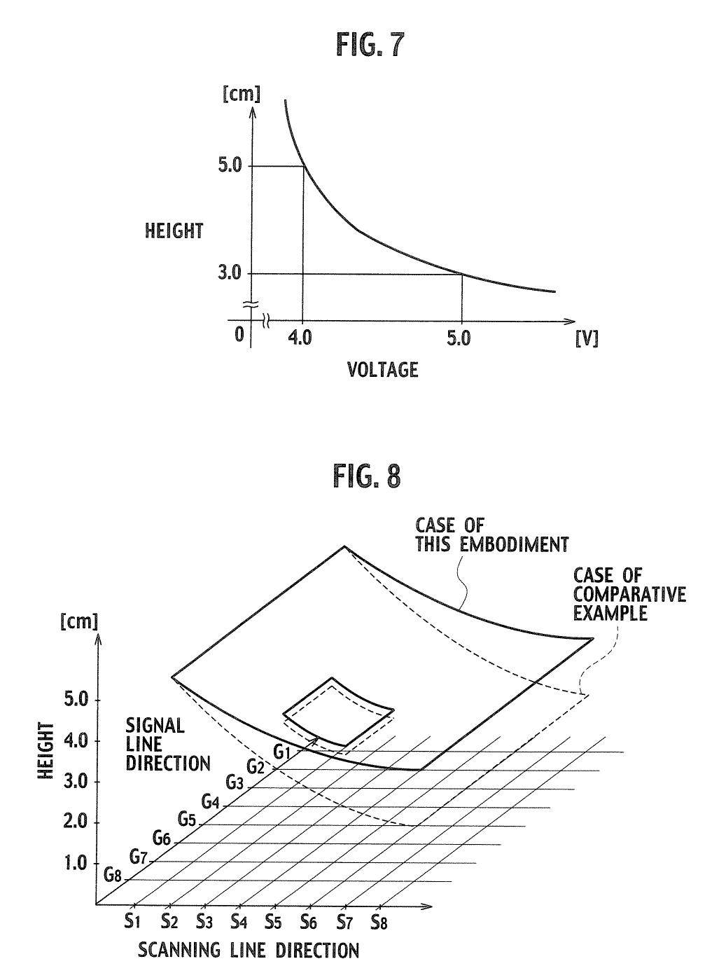

For this reason, the voltage value of each image-capturing region 4, which voltage is detected by the sensor detection circuit 32 at time tx shown in FIG. 4 in the comparative example (see FIG. 3), can be shown as in FIG. 6A, for example. On the other hand, the voltage value in this embodiment allows a reduction in the field-through voltage generated by the respective input switching elements SWa. Accordingly, the voltage value in this embodiment can be shown as in, for example, FIG. 6B as compared with FIG. 6A. Further, the voltage detected by the sensor detection circuit 32 is converted using a conversion table of the voltage and the height as illustrated in FIG. 7, whereby the captured image can be reconstructed using the voltage value of each image-capturing region 4 illustrated in FIG. 6A and FIG. 6B.

FIG. 8 is an inclined view illustrating reconstruction of the captured image using the voltage values illustrated in FIGS. 6A and 6B. As illustrated in FIG. 8, in this embodiment, the voltages stored on the respective sensor capacitors 9 are made more equal to one another than the comparative example. This makes it possible to prevent the occurrence of in-plane inclination in the captured image of the detected object.

Incidentally, the method for reducing the filed-through voltage using the field-through compensation switch 15 as explained in this embodiment is not limited to the image-capturing regions 4. For example, the method can be applied to the display region 3 having the same configuration as that of the image-capturing region 4 (see FIG. 3). In addition, although the explanation is omitted, the same configuration of the display region 3 as that shown in, for example, FIG. 3 may be used in the display region 3 of this embodiment.

According to this embodiment, the negative electric charge, which is leaked when the input switching element SWa is changed from ON to OFF, is cancelled with the positive electric charge. In this way, in this embodiment, it is possible to reduce the field-through voltage generated by the input switching elements SWa.

### Second Embodiment

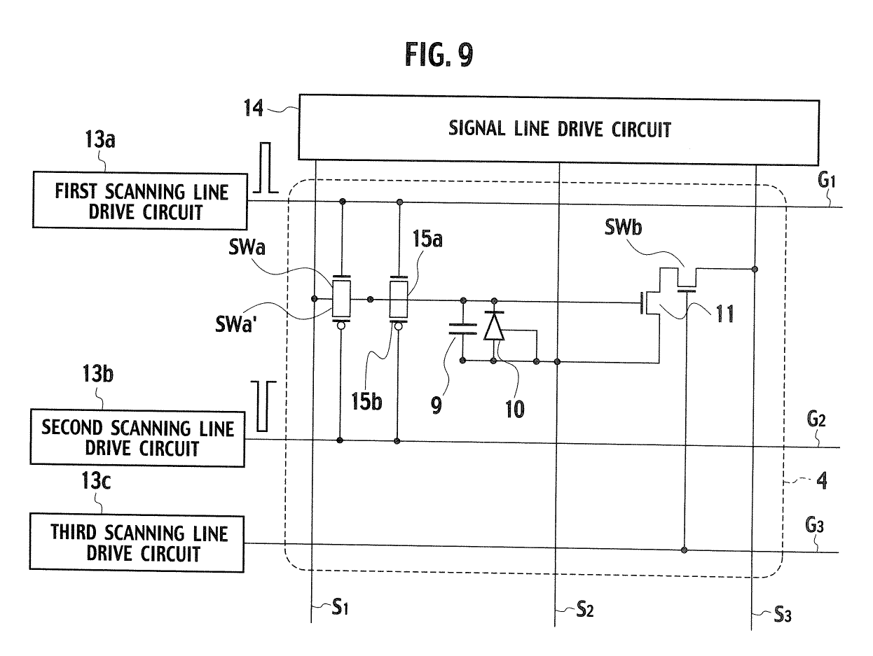

FIG. 9 is a configuration view illustrating the configuration of the image-capturing region 4 in the second embodiment. The basic configuration components of the display device 1 in this embodiment are the same as those in the first embodiment and explanation of overlapped portions is omitted here.

The display device 1 of this embodiment further includes: a second input switching element SWa′; a first field-through compensation switch 15a; a second field-through compensation switch 15b; and a second scanning drive circuit 13b that controls ON/OFF of the second input switching element SWa′ and the second field-through compensation switch 15b, in addition to the basic configuration components.

In other words, the first embodiment refers to the field-through compensation for monopolar input switching elements. On the other hand, this embodiment refers to the field-through compensation for bipolar input switching elements, namely, the input switching element SWa and the second input switching element SWa′.

The second input switching element SWa′ is connected to the input switching element SWa in parallel, and the gate electrode is connected to the second scanning line G2. Then, the second input switching element SWa′ operates in a direction opposite to that of the ON/OFF operation of the input switching element SWa. The first field-through compensation switch 15a is connected between the other electrode of the input switching element switch SWa and one electrode of the sensor capacitor 9 connected to this other electrode, and the gate line is connected to the first scanning line G1. Then, the first field-through compensation switch 15a operates in the same direction as that of the ON/OFF operation of the input switching element SWa. The second field-through compensation switch 15b is connected between the other electrode of the second input switching element SWa′ and one electrode of the sensor capacitor 9 connected to this other electrode, and the gate line is connected to the second scanning line G2. Then, the second field-through compensation switch 15b operates in the same direction as that of the ON/OFF operation of the second input switching element SWa′. Moreover, the second scanning line drive circuit 13b supplies the second scanning line G2 with the driving signal, having polarity opposite to that of the driving signal supplied by the first scanning line drive circuit 13a, similar to the first embodiment.

It is possible to use, for example, thin film transistors as the input switching element SWa and the first field-through compensation switch 15a, and this embodiment gives an explanation using the n-channel thin film transistors. Moreover, it is also possible to use, for example, thin film transistors as the second input switching element SWa′ and the second field-through compensation switch 15b, and this embodiment gives an explanation using the p-channel thin film transistors.

The operation of the image-capturing function in the image-capturing region 4 is the same as the operation explained in the first embodiment, and explanation of overlapped portions is omitted here.

Next, the following will explain the operation principle in which the first field-through compensation switch 15a and the second field-through compensation switch 15b achieve a reduction in the field-through voltage during the image-capturing period.

During the precharge period, the input switching element SWa is controlled so as to be turned on, and therefore an n-channel having a negative charge (negative electron) is formed between source and drain of an n-channel thin film transistor that constitutes the input switching element SWa. Moreover, the second input switching element SWa′ is also controlled so as to be turned on, and therefore a p-channel having a positive charge (positive hole) is formed between source and drain of a p-channel thin film transistor that constitutes the second input switching element SWa′.

At this time, the first field-through compensation switch 15a is also controlled so as to be turned on. Thus, an n-channel having a negative charge is formed between source and drain of an n-channel thin film transistor that constitutes the first field-through compensation switch 15a. Moreover, the second field-through compensation switch 15b is also controlled so as to be turned on. Thus, a p-channel having a positive charge is formed between source and drain of a p-channel thin film transistor that constitutes the second field-through compensation switch 15b.

During the following image-capturing period, the input switching element SWa is controlled so as to be turned from ON to OFF. Consequently, the negative charge that is charged on the n-type channel is discharged (leaked) to a source electrode or drain electrode of the n-channel thin film transistor. Likewise, the second input switching element SWa′ is controlled so as to be turned from ON to OFF. Consequently, the positive charge that is charged on the p-type channel is discharged (leaked) to a source electrode or drain electrode of the p-channel thin film transistor.

However, in this embodiment, the first field-through compensation switch 15a and the second field-through compensation switch 15b are provided. This provision cancels the negative charge leaked from the input switching element SWa and the positive charge leaked from the second input switching element SWa′ by means of the positive charge discharged from the second field-through compensation switch 15b and the negative change discharged from the first field-through compensation switch 15a, respectively. Thus, the field-through voltage can be reduced. Incidentally, the input switching element SWa and the second input switching element SWa′ are directly connected to the sensor capacitor 9. As a result, although all negative charge and positive charge leaked from the input switching element SWa and the second input switching element SWa′ cannot be reduced, the provision of the first field-through compensation switch 15a and the second field-through compensation switch 15b makes it possible to reduce the field-through voltage.

Moreover, similar to the first embodiment, the field-through voltage is reduced using the first field-through compensation switch 15a and the second field-through compensation switch 15b. Thus, it is possible to reduce the difference between the field-through voltages generated by the respective switching elements SWa at the starting end and the terminating end.

Furthermore, similar to the first embodiment, the difference between the field-through voltages generated by the respective switching elements SWa at the starting end and the terminating end is reduced. Thus, it is possible to equalize the voltages stored on the respective sensor capacitors 9 connected to the respective input switching elements SWa. In other words, it is possible to suppress the characteristic variation of the sensor section having the sensor capacitors 9 and the photodiodes 10, and to prevent the occurrence of in-plane inclination in the captured image of the detected object.

Incidentally, the method for reducing the filed-through voltage using the first field-through compensation switch 15a and the second field-through compensation switch 15b as explained in this embodiment is not limited to the image-capturing regions 4, and the method can be applied to the display region 3 having the same configuration as that of the image-capturing region 4 (see FIG. 3).

According to this embodiment, the negative electric charge, which is leaked when the input switching element SWa is changed from ON to OFF, is cancelled with the positive electric charge using the second field-through compensation switch 15b, and the positive electric charge, which is leaked when the second input switching element SWa′ is changed from ON to OFF, is cancelled with the negative electric charge using the first field-through compensation switch 15a. Therefore, according to this embodiment, it is possible to reduce the field-through voltage generated by the input switching elements SWa and the second input switching element SWa′.

### Third Embodiment

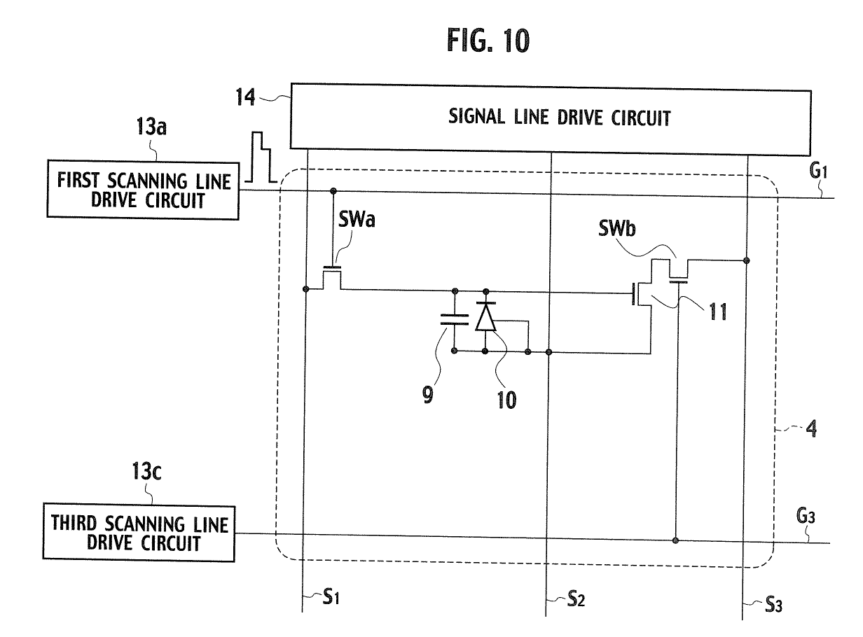

FIG. 10 is a configuration view illustrating the configuration of the image-capturing region 4 in a third embodiment. The basic configuration components of the display device 1 in this embodiment are the same as those in the first embodiment excepting the second scanning line G2, and explanation of overlapped portions is omitted here.

The first scanning line drive circuit 13a in the present display device 1 supplies the first scanning line G1a with a driving signal, having a waveform whose fall characteristic changes stepwise.

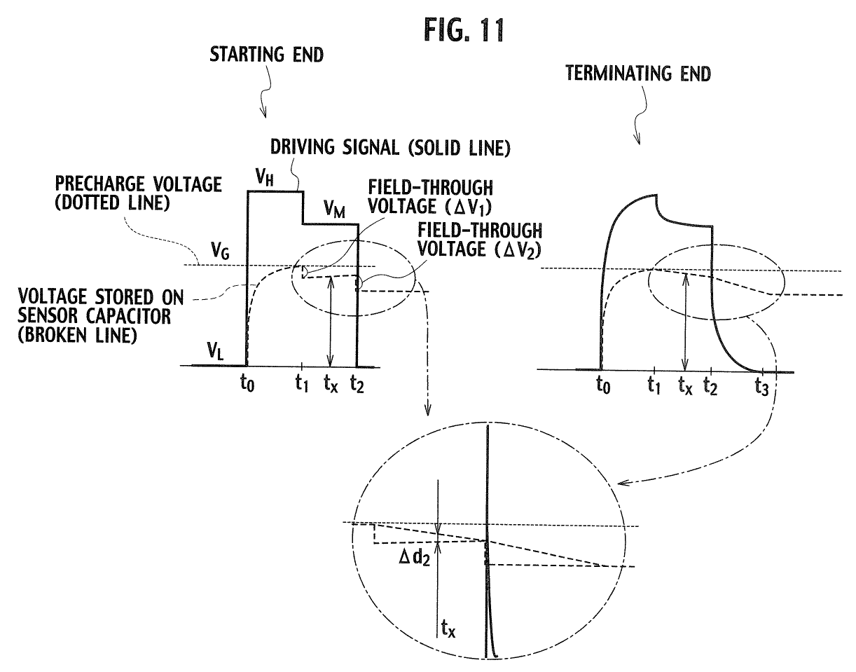

FIG. 11 is a comparison diagram illustrating comparison in an amount of the voltage stored on the respective sensor capacitors 9 at the starting end and the terminating end that are arranged on the same scanning line using the driving signal, having a waveform whose fall characteristic changes stepwise. Similar to the case in FIG. 4, a solid line indicates the waveform of the driving signal that the scanning line drive circuit 13a supplies to the first scanning line G1. A dotted line shows a precharge voltage that the signal line driving circuit 14 supplies to the first signal line S1. A broken line shows the voltage stored on the sensor capacitor 9.

First, an explanation will be given of the amount of the voltage stored on the sensor capacitor 9 at the starting end illustrated left in FIG. 11. The signal line S1 and the sensor capacitor 9 are electrically connected to each other with the rise (VL→VH) of the driving signal at time t0. The precharge voltage VG supplied to the signal line S1 by the signal line drive circuit 14 is stored on the sensor capacitor 9. Then, a field-through voltage ΔV1 is generated in the thin film transistor that constitutes the input switching element SWa with the fall (VH→VM) of the driving signal at time t1 and therefore the amount of the voltage stored on the sensor capacitor 9 becomes (VG−ΔV1). Next, a field-through voltage ΔV2 is generated with the fall (VM→VL) of the driving signal at time t2, and therefore the amount of the voltage stored on the sensor capacitor 9 becomes (VG−ΔV1−ΔV2).

The input switching element SWa at the starting end is placed at a position closer to the first scanning line drive circuit 13a than the input switching element SWa at the terminating end. The driving signal supplied to the gate electrode of the input switching element SWa at the starting end is little influenced by the resistance of the first scanning line G1, the parasitic capacitance and the like. Accordingly, time, which is required for the voltage of the driving signal supplied to the control electrode to fall from VH to VL, is little generated. Additionally, time, which is required for the voltage of the driving signal to fall from VM to VL, is little generated. Moreover, time, which is required for generation of the field-through voltage ΔV1, and time, which is required for generation of the field-through voltage ΔV2, are little generated. Therefore, the amount of the voltage stored on the sensor capacitor 9 at the starting end becomes (VG−ΔV1) at time t1 and (VG−ΔV1−ΔV2) at time t2.

Next, an explanation will be given of the amount of the voltage stored on the sensor capacitor 9 at the terminating end illustrated right in the same figure. The input switching element SWa at the terminating end is placed at a position farther from the first scanning line drive circuit 13a than the input switching element SWa at the starting end. In the driving signal supplied to the gate electrode of the input switching element SWa at the terminating end, the waveform is distorted by the influence of such as the resistance of the first scanning line G1 and the like. For this reason, predetermined time (t1−t2) is required when the voltage of the driving signal supplied to the gate electrode falls from VH to VM and the filed-through voltage ΔV1 gradually increases along with the predetermined time. Moreover, predetermined time (t2−t3) is required when the voltage of the driving signal falls from VM to VL and the filed-through voltage ΔV2 gradually increases along with the predetermined time. Therefore, the amount of electric charge stored on the sensor capacitor 9 at the terminating end decreases from (VG) to (VG−ΔV1) with a change in time (t1→t2) and decreases from (VG−ΔV1) to (VG−ΔV1−ΔV2) with a change in time (t2→t3).

Finally, the following will explain a difference in an amount of the voltage between the respective sensor capacitors 9 at the starting end and terminating end illustrated at the lower portion in the same figure. This figure shows the amount of the voltage stored on each of the sensor capacitors 9 at the starting end and the terminating end in an overlapped form. The amount of the voltage stored on each of the sensor capacitors 9 becomes (VG−ΔV1−ΔV2) when the aforementioned predetermined time has passed.

However, at the time tx before passage of the predetermined time, the amount of the field-through voltage generated by each of the input switching elements SWa at the starting end and terminating end differs, so that the amount of the voltage stored on each sensor capacitor 9 also differs. It is here assumed that the voltage difference between the sensor capacitor 9 at the starting end and the sensor capacitor 9 at the terminating end at time tx is Δd2. Moreover, suppose that the voltage difference between the sensor capacitor 9 at the starting end and the sensor capacitor 9 at the terminating end at time tx is Δd1 as shown in FIG. 4.

In the case of the driving signal having a rectangular waveform at the starting end shown in FIG. 4, a potential variation of the gate electrode at time t1 is VH→VL. On the other hand, in the case of the driving signal having a rectangular waveform whose fall characteristic changes stepwise at the starting end shown in FIG. 11, a potential variation of the gate electrode at time t1 is VH→VM. For this reason, if the potential difference Δd2 between the respective sensor capacitors 9 in this embodiment shown in FIG. 11 is compared with the potential difference Δd1 between the respective sensor capacitors 9 shown in FIG. 4, the potential difference Δd2 is smaller than the potential difference Δd1. In other words, the fall characteristic of the driving signal is changed stepwise, thereby making it possible to reduce the difference between the field-through voltages generated by the respective switching elements SWa which are arranged at the starting end and the terminating end, respectively.

Moreover, similar to the first embodiment, the difference between the field-through voltages generated by the respective switching elements SWa at the starting end and the terminating end is reduced, thereby making it possible to equalize the voltages stored on the respective sensor capacitors 9 connected to the respective input switching elements SWa. In other words, it is possible to suppress the characteristic variation of the sensor section having the sensor capacitors 9 and the photodiodes 10, and to prevent the occurrence of in-plane inclination in the captured image of the detected object.

Incidentally, in this embodiment, the fall of two stages has been explained as an example of the driving signal having a waveform whose fall characteristic changes stepwise; however, the same effect as that of this embodiment can be obtained even when the number of stages is more than two. The potential variation of the gate electrode is further reduced as the number of stages is increased, and therefore it is possible to further decrease the difference between voltages stored on the respective sensor capacitors 9 at the starting end and the terminating end.

Furthermore, the method for supplying the driving signal having the changed fall characteristic as explained in this embodiment is not limited to the image-capturing region 4. The method can be applied to the display region 3 having the same configuration as that of the image-capturing region 4 (see FIG. 3).

In this embodiment, the input switching element SWa is driven using the driving signal whose fall characteristic changes stepwise. Therefore, according to this embodiment, it is possible to reduce the potential variation of the control electrode of the input switching element SWa at the fall time, and to decrease the difference between the field-through voltages generated by the respective switching elements SWa arranged on the first scanning line G1.

### Fourth Embodiment

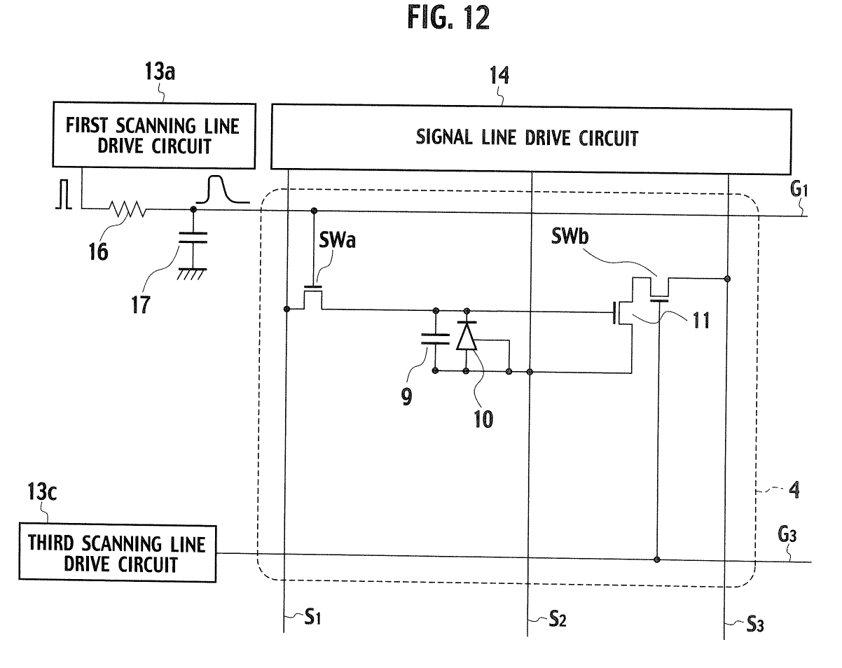

FIG. 12 is a configuration view illustrating the configuration of the image-capturing region 4 in the fourth embodiment. The basic configuration components of the display device 1 in this embodiment are the same as those in the first embodiment excepting the second scanning line G2, and explanation of overlapped portions is omitted here.

The present display device 1 is configured to further include: a resistor 16 connected between the first scanning lie G1 and the first scanning line drive circuit 13a; and a load capacitor 17 connected to one electrode of the resistor 16 connected to the first scanning line G1.

By use of the resistor 16 and the load capacitor 17, the display device 1 of this embodiment supplies the first scanning line G1 with the driving signal having a fall time, which is longer than or equal to a fall time of the driving signal having a distortion occurring at the terminating end when the driving signal is supplied to the starting end of the first scanning line G1. In this way, it is possible to equalize the driving signal waveform at the starting end and the driving signal waveform at the terminating end.

The respective input switching elements SWa connected to the first scanning line G1 are controlled so as to be turned on/off using the driving signal having the same waveform, and therefore it is possible to reduce the difference between the field-through voltages generated by the respective switching elements SWa.

Moreover, similar to the first embodiment, the difference between the field-through voltages generated by the respective switching elements SWa at the starting end and the terminating end is reduced, thereby making it possible to equalize voltages stored on the respective sensor capacitors 9 connected to the respective input switching elements SWa. In other words, it is possible to suppress the characteristic variation of the sensor section having the sensor capacitors 9 and the photodiodes 10, and to prevent the occurrence of in-plane inclination in the captured image of the detected object.

Incidentally, the method for distorting the waveform of the driving signal in advance by connecting the resistor 16 and the load capacitor 17 as explained in this embodiment is not limited to the image-capturing region 4. The method can be applied to the display region 3 having the same configuration as that of the image-capturing region 4 (see FIG. 3).

According to this embodiment, the first scanning line G1 is supplied with the driving signal having a fall time, which is longer than or equal to a fall time of the driving signal having a distortion occurring at the terminating end when the driving signal is supplied to the starting end of the first scanning line G1. Therefore, according to this embodiment, it is possible to equalize the waveform of the driving signal at the starting end of the first scanning line G1 and the waveform at the terminating end, and to reduce the difference between the field-through voltages generated by the respective switching elements SWa arranged on the first scanning line G1.

What is claimed is:

1. A field-through compensation circuit comprising:
a first switching element; and
a first field-through compensation switch connected to the first switching element in series to cancel, a first electric charge leaked when the first switching element is changed from ON to OFF, by using a second electric charge having polarity opposite to that of the first electric charge.

2. The field-through compensation circuit according to claim 1, further comprising:
a second switching element connected to the first switching element in parallel; and
a second field-through compensation switch connected to the second switching element in series to cancel, a third electric charge leaked when the second switching element is changed from ON to OFF, by using a fourth electric charge having polarity opposite to that of the third electric charge.

3. A display device comprising:
a plurality of signal lines and a plurality of scanning lines crossing one another;
switching elements having a control electrode connected to the corresponding scanning line, and having one electrode connected to the corresponding signal line; and
a drive unit that supplies the corresponding scanning line with a driving signal whose fall characteristic changes stepwise.

4. A display device comprising:
a plurality of signal lines and a plurality of scanning lines crossing one another;
switching elements having a control electrode connected to the corresponding scanning line, and having one electrode connected to the corresponding signal line; and
a drive unit that supplies the corresponding scanning line with a driving signal having a fall time, which is longer than or equal to a fall time of a driving signal having a distortion occurring at a terminating end when the driving signal is supplied to a starting end of the corresponding scanning line.

5. The display device according to claim 4, wherein the drive unit uses a resistor and a load capacitor to supply the corresponding scanning line with a driving signal having a fall time, which is longer than or equal to a fall time of a driving signal having a distortion occurring at a terminating end when the driving signal is supplied to a starting end of the corresponding scanning line.
